(19) United States
(12) Patent Application Publication
(10) Pub. No.: US 2026/0213894 A1
(43) Pub. Date: Jul. 23, 2026

(54) MANAGING ASSOCIATED IDENTIFIERS IN AI/ML-BASED POSITIONING

(71) Applicant: Nokia Technologies Oy, Espoo (FI)

(72) Inventors: Keeth Saliya Jayasinghe LADDU, Espoo (FI); Dick CARRILLO MELGAREJO, Espoo (FI); Muhammad Ikram ASHRAF, Espoo (FI)

(21) Appl. No.: 19/452,677

(22) Filed: Jan. 19, 2026

Related U.S. Application Data
(60) Provisional application No. 63/747,200, filed on Jan. 20, 2025.

(51) Int. Cl. H04L 5/00

(52) U.S. Cl. CPC H04L 5/0035; H04L 5/0048

(57) ABSTRACT

Example embodiments of the present disclosure are directed to managing associated identifiers in AI/ML based positioning. A method comprises receiving a first configuration of a plurality of transmission-reception points (TRPs) for data collection for model training and a first association identification associated with at least one TRP of the first configuration; receiving a second configuration of a plurality of TRPs for inference, the first association identification associated with at least one TRP of the second configuration; receiving, for the first association identification, positioning signal transmission from the at least one TRP of the second configuration; collecting, for the first association identification, measurements based on the received positioning signal transmission; and selecting a positioning model corresponding to the first association identification for inference, the at least one TRP of the first configuration and the at least one TRP of the second configuration determined to be with consistent physical properties.

### CROSS-REFERENCE TO RELATED APPLICATION

This application claims priority from, and the benefit of, US Provisional Application No. 63/747200, filed January 20, 2025, which is hereby incorporated by reference in its entirety.

### FIELD

Various example embodiments of the present disclosure generally relate to the field of telecommunication and in particular, to methods, devices, apparatuses and computer readable storage medium for managing associated identifiers (IDs) in Artificial Intelligence Machine Learning (AI/ML) based positioning.

### BACKGROUND

Efforts on leveraging AI/ML models to enhance positioning accuracy and manage lifecycle operations have been introduced to the related wireless communication standards, enabling consistency between training and inference phases. AI/ML-based positioning systems rely on both UE-sided and network-sided models, necessitating signaling mechanisms for model training, activation, switching, and performance monitoring. Enabling consistency between training and inference conditions is a key factor as discrepancies between the two phases, especially those arising from network-side (NW-side) additional conditions such as environmental factors or TRP configurations, can reduce model performance.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, information comprising a first configuration of a plurality of transmission-reception points (TRPs) and a first association identification, the first association identification associated with at least one TRP of the first configuration of the plurality of TRPs; receive, from the second apparatus, information comprising a second configuration of a plurality of TRPs, the first association identification associated with at least one TRP of the second configuration of the plurality of TRPs; and determine, for the first association identification, that the at least one TRP of the first configuration of the plurality of TRPs and the at least one TRP of the second configuration of the plurality of TRPs are with consistent physical properties.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, information comprising a first configuration of a plurality of transmission-reception points (TRPs) and a first association identification, the first association identification associated with at least one TRP of the first configuration of the plurality of TRPs, and transmit, to the first apparatus, information comprising a second configuration of a plurality of TRPs, the first association identification associated with at least one TRP of the second configuration of the plurality of TRPs, wherein for the first association identification, the at least one TRP of the first configuration of the plurality of TRPs and the at least one TRP of the second configuration of the plurality of TRPs are determined to be with consistent physical properties.

In a third aspect of the present disclosure, there is provided a first apparatus. The first apparatus comprises at least one processor; and at least one memory storing instructions that, when executed by the at least one processor, cause the first apparatus at least to: receive, from a second apparatus, information comprising a first configuration of a plurality of transmission-reception points (TRPs) and a first association identification, the first association identification associated with at least one TRP of the first configuration of the plurality of TRPs, and the first configuration of the plurality of TRPs is received for data collection for model training; receive, from the second apparatus, information comprising a second configuration of a plurality of TRPs, the first association identification associated with at least one TRP of the second configuration of the plurality of TRPs, and the second configuration of the plurality of TRPs is received for inference; receive, for the first association identification, positioning signal transmission from the at least one TRP of the second configuration of the plurality of TRPs; collect, for the first association identification, measurements based on the received positioning signal transmission; and select a positioning model corresponding to the first association identification for inference, wherein the at least one TRP of the first configuration of the plurality of TRPs and the at least one TRP of the second configuration of the plurality of TRPs are determined to be with consistent physical properties;

In a fourth aspect of the present disclosure, there is provided a method. The method comprises: receiving, from a second apparatus, information comprising a first configuration of a plurality of transmission-reception points (TRPs) and a first association identification, the first association identification associated with at least one TRP of the first configuration of the plurality of TRPs; receiving, from the second apparatus, information comprising a second configuration of a plurality of TRPs, the first association identification associated with at least one TRP of the second configuration of the plurality of TRPs; and determining, for the first association identification, that the at least one TRP of the first configuration of the plurality of TRPs and the at least one TRP of the second configuration of the plurality of TRPs are with consistent physical properties.

In a fifth aspect of the present disclosure, there is provided a method. The method comprises: transmitting, to a first apparatus, information comprising a first configuration of a plurality of transmission-reception points (TRPs) and a first association identification, the first association identification associated with at least one TRP of the first configuration of the plurality of TRPs, and transmitting, to the first apparatus, information comprising a second configuration of a plurality of TRPs, the first association identification associated with at least one TRP of the second configuration of the plurality of TRPs, wherein for the first association identification, the at least one TRP of the first configuration of the plurality of TRPs and the at least one TRP of the second configuration of the plurality of TRPs are determined to be with consistent physical properties.

In a sixth aspect of the present disclosure, there is provided a method. The method comprises: receiving, from a second apparatus, information comprising a first configuration of a plurality of transmission-reception points (TRPs) and a first association identification, the first association identification associated with at least one TRP of the first configuration of the plurality of TRPs, and the first configuration of the plurality of TRPs is received for data collection for model training; receiving, from the second apparatus, information comprising a second configuration of a plurality of TRPs, the first association identification associated with at least one TRP of the second configuration of the plurality of TRPs, and the second configuration of the plurality of TRPs is received for inference; receiving, for the first association identification, positioning signal transmission from the at least one TRP of the second configuration of the plurality of TRPs; collecting, for the first association identification, measurements based on the received positioning signal transmission; and performing inference using a positioning model corresponding to the first association identification, wherein the at least one TRP of the first configuration of the plurality of TRPs and the at least one TRP of the second configuration of the plurality of TRPs are determined to be with consistent physical properties;

In a seventh aspect of the present disclosure, there is provided a first apparatus. The first apparatus comprises means for receiving, from a second apparatus, information comprising a first configuration of a plurality of transmission-reception points (TRPs) and a first association identification, the first association identification associated with at least one TRP of the first configuration of the plurality of TRPs; means for receiving, from the second apparatus, information comprising a second configuration of a plurality of TRPs, the first association identification associated with at least one TRP of the second configuration of the plurality of TRPs; and means for determining, for the first association identification, that the at least one TRP of the first configuration of the plurality of TRPs and the at least one TRP of the second configuration of the plurality of TRPs are with consistent physical properties.

In an eighth aspect of the present disclosure, there is provided a second apparatus. The second apparatus comprises means for transmitting, to a first apparatus, information comprising a first configuration of a plurality of transmission-reception points (TRPs) and a first association identification, the first association identification associated with at least one TRP of the first configuration of the plurality of TRPs, and means for transmitting, to the first apparatus, information comprising a second configuration of a plurality of TRPs, the first association identification associated with at least one TRP of the second configuration of the plurality of TRPs, wherein for the first association identification, the at least one TRP of the first configuration of the plurality of TRPs and the at least one TRP of the second configuration of the plurality of TRPs are determined to be with consistent physical properties.

In a ninth aspect of the present disclosure, there is provided a first apparatus. The first apparatus comprises means for receiving, from a second apparatus, information comprising a first configuration of a plurality of transmission-reception points (TRPs) and a first association identification, the first association identification associated with at least one TRP of the first configuration of the plurality of TRPs, and the first configuration of the plurality of TRPs is received for data collection for model training; means for receiving, from the second apparatus, information comprising a second configuration of a plurality of TRPs, the first association identification associated with at least one TRP of the second configuration of the plurality of TRPs, and the second configuration of the plurality of TRPs is received for inference; means for receiving, for the first association identification, positioning signal transmission from the at least one TRP of the second configuration of the plurality of TRPs; means for collecting, for the first association identification, measurements based on the received positioning signal transmission; and means for performing inference using a positioning model corresponding to the first association identification, wherein the at least one TRP of the first configuration of the plurality of TRPs and the at least one TRP of the second configuration of the plurality of TRPs are determined to be with consistent physical properties;

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example signaling process in accordance with some embodiments in the disclosure;

FIG. 3 illustrates a flowchart of a method implemented at a first apparatus in accordance with some example embodiments of the present disclosure;

FIG. 4 illustrates a flowchart of a method implemented at a second apparatus in accordance with some example embodiments of the present disclosure;

FIG. 5 illustrates a flowchart of a method implemented at a first apparatus in accordance with some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,”…, etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

Example embodiments of the present disclosure will be described in detail below with reference to the accompanying drawings.

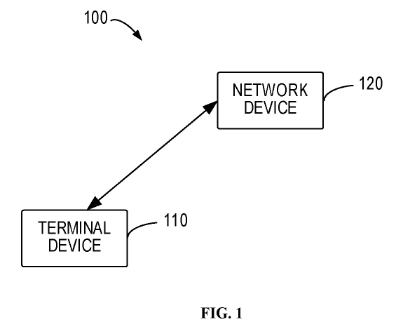

FIG. 1 illustrates an example communication environment 100 in which example embodiments of the present disclosure can be implemented. In the communication environment 100, a plurality of communication devices, including a terminal device 110 and a network device 120, can communicate with each other. In the example of FIG. 1, the terminal device 110 may be a UE and the network device 120 may be a base station serving the UE. The serving area of the network device 120 may be called a cell.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell, and one or more additional cells may be deployed in the communication environment 100. It is noted that although illustrated as a network device, the network device 120 may be another device than a network device. Although illustrated as a terminal device, the terminal device 110 may be another device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, a transmission direction from the network device 120 to the terminal device 110 is referred to as a downlink (DL), while a transmission direction from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

Communications in the communication environment 100 may be implemented according to any proper communication protocol(s), comprising, but not limited to, cellular communication protocols, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the context of 5G and 6G networks, a gNB (e.g., the network device 120 in FIG. 1) often operates in conjunction with a cluster of physical Transmission Reception Points (TRPs), which are distributed radio units (RUs) that enable efficient communication and positioning capabilities. These physical TRPs are not fully visible to the UE (e.g. the terminal device 110 in FIG. 1); instead, the network (NW) implementation determines which TRPs within the cluster are selected for specific tasks, such as Positioning Reference Signal (PRS) transmissions. Depending on the requirements of a UE positioning method, the network may configure one or more TRPs from the cluster for PRS transmission. This selection is entirely at the discretion of the NW implementation, enabling dynamic and flexible resource allocation.

The NW may also decide to use a subset of TRPs from the cluster when supporting positioning methods, whether AI/ML-based or traditional (non-AI/ML). Here, TRPs refer to the physical units that are managed by the NW, and there is no restriction in the LTE Positioning Protocol (LPP) or New Radio Positioning Protocol Annex (NRPPa) specifications regarding mapping multiple physical TRPs to a single logical TRP. This mapping may change over time based on NW preferences. For instance, when the Location Management Function (LMF) configures a Physical Cell Identifier (PCI) for a TRP (an optional configuration), the UE may perceive one logical TRP under that PCI. However, in reality, the NW may use two or more physical TRPs under the same PCI and has the flexibility to switch between these physical TRPs as needed over time.

In legacy non-AI/ML positioning methods, such dynamic changes in TRP selection do not pose significant issues. These methods typically rely on the latest measurements from the currently active TRPs to determine the UE’s position. Older measurements, even if collected from a different combination of TRPs hours, days, or months prior, are irrelevant to the positioning estimate. Thus, the NW’s ability to dynamically change TRPs over time does not affect the accuracy or reliability of non-AI/ML positioning methods.

In contrast, AI/ML-based positioning methods introduce challenges when the TRPs selected during the data collection (training) stage differ from the TRPs selected during the inference stage (or at later times). AI/ML-based positioning methods often rely on the data collected from specific TRPs and the exact locations of those TRPs to train models that predict the UE’s position. If the NW dynamically changes the physical TRPs over time or during inference, inconsistencies may arise between the training and inference stages. These inconsistencies can degrade the accuracy of the AI/ML model since the positioning predictions depend on the consistency and reliability of the TRP data used during training.

One proposed solution to this issue for AI/ML-based positioning methods is to provide explicit information about the locations of the physical TRPs. This would enable the UE to track the data collected from different TRPs and use that information during the inference stage to assess the applicability of the trained models. However, disclosing TRP locations introduces significant concerns for the NW, as these locations often contain proprietary information that the network operator may be reluctant to share. Revealing such details could compromise the competitive advantage of the network or expose sensitive deployment strategies.

To address this challenge, there have been discussions about introducing an “associated ID” for positioning purposes. This associated ID could serve as a reference to indicate which TRPs were used during the training phase without explicitly revealing their locations. While this approach has the potential to resolve the consistency issue between training and inference, the exact details of how the associated ID mechanism would function are still under consideration. The associated ID could allow the UE to correlate the data used in training with the data available during inference, enabling alignment without requiring the network to disclose proprietary information.

This balance between maintaining network confidentiality and enabling the robustness of AI/ML-based positioning methods remains a critical area of exploration. By carefully designing mechanisms such as associated IDs, the network can support high-accuracy positioning methods while safeguarding its proprietary assets. However, further research and standardization efforts are needed to refine these solutions and fully address the challenges introduced by dynamic TRP selection in AI/ML-based positioning.

To address the consistency problem in AI/ML-based positioning systems, a procedure leveraging the concept of the associated ID is proposed in the disclosure. This approach enables that the relationship between physical TRPs and their logical representation remains consistent across data collection and inference phases, thereby enhancing the reliability of AI/ML models. In the following, the core concept proposed in the disclosure will be briefly discussed.

In this proposed solution, network vendors may assign an associated ID to represent the physical properties of a selected subset of TRPs within a cluster. For example, in a cluster containing eight TRPs, if only four TRPs are selected for configuration at any given time, the network may assign at least one unique associated ID to represent the physical properties of those four TRPs. This mapping allows the network to maintain a clear and consistent association between logical TRPs and their physical counterparts over time.

From a signaling perspective, the LMF may receive an associated ID from an NG-RAN node, such as a gNB, as part of the TRP information response. The NG-RAN node may assign the associated ID to represent the geographical locations and configurations of a specific set of TRPs at a given time. In some cases, the LMF may receive multiple associated IDs from different NG-RAN nodes. These IDs may then be used by the LMF during both the data collection and inference stages to enable alignment in positioning calculations. Further details on signaling mechanisms are elaborated later in the disclosure.

The associated ID, linked to specific TRP information, may also be transmitted to the UE by either the LMF (via LTE Positioning Protocol or LPP) or the gNB (via Radio Resource Control or RRC). This information may be shared during both the data collection and inference configurations. When the UE receives the same associated ID for a set of TRPs over time within a defined cell area (e.g., represented by AreaID-CellList), the UE may assume similar physical properties for that set of TRPs. These assumptions are based on consistency rules that enable the following:
1. Number of TRPs: The same associated ID always represents the same number of TRPs. For instance, if associated ID #1 is configured for three TRPs (TRP1, TRP2, TRP3) in the initial configuration, associated ID #1 should always be associated with three TRPs in future configurations.
2. Ordering of Physical TRPs: While the logical ordering of TRPs may change, the underlying mapping to physical TRPs remains consistent. For example, if associated ID #1 initially maps TRP1, TRP2, and TRP3 to physical TRPs P-TRP2, P-TRP5, and P-TRP7, the same mapping (P-TRP2, P-TRP5, P-TRP7) should be maintained in subsequent configurations.
3. Geographical Location Consistency: The TRPs represented by the same associated ID have similar geographical locations over time. If associated ID #1 initially maps TRPs to geographical locations G1, G2, and G3, the network enables that future TRPs mapped to associated ID #1 remain geographically close to G1, G2, and G3, within a predefined margin.
4. Reference TRP Consistency: If a reference TRP is tied to an associated ID, the same physical TRP should always serve as the reference TRP for that associated ID. For instance, if TRP1 (mapped to P-TRP1) is the reference TRP under associated ID #1, this relationship should remain unchanged during both training and inference phases.

These consistency rules are communicated to the UE to enable alignment in training and inference phases. By adhering to these rules, the UE can accurately interpret data collected during training and apply it during inference, even when the network dynamically reconfigures TRPs within a cluster.

The proposed method addresses potential concerns about network confidentiality. By using associated IDs instead of directly disclosing TRP details (e.g., geographical locations or physical configurations), the network can safeguard proprietary information while enabling the consistency required for AI/ML-based positioning. This approach strikes a balance between maintaining high positioning accuracy and preserving network confidentiality, enabling robust and efficient positioning in dynamic and complex network environments.

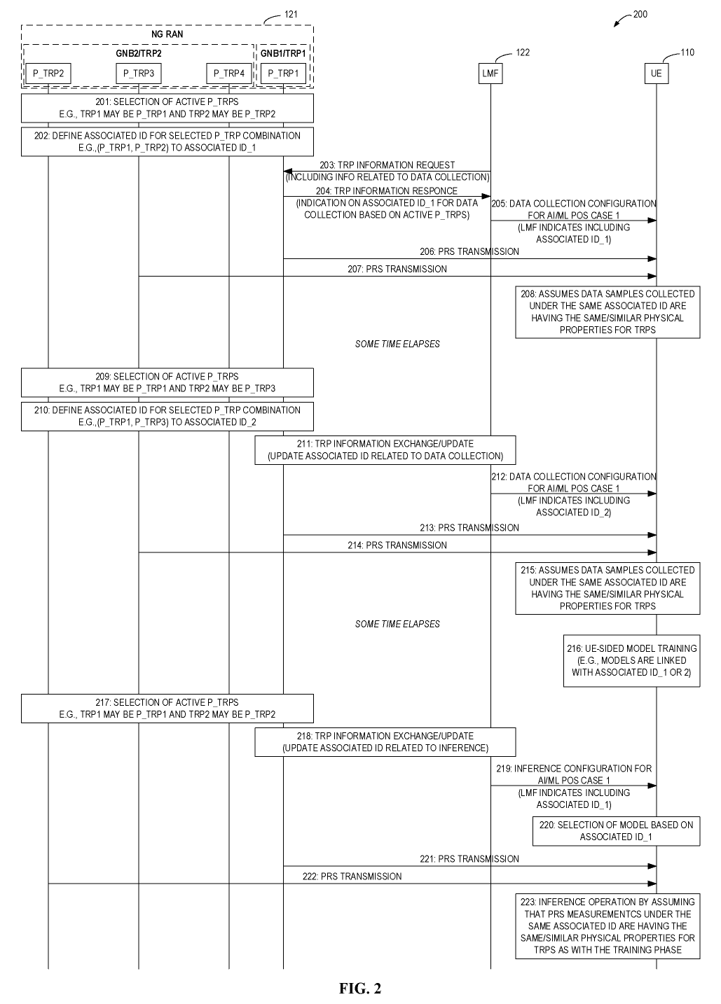

Referring now to FIG. 2, which illustrates an example signaling process in accordance with some embodiments in the disclosure. In the following, an overview of the process is first introduced and followed by a detailed introduction.

### Assignment of Associated IDs by Network Vendors

Network vendors may assign 201, 202 Associated IDs to represent the physical properties of TRPs grouped or selected from a cluster. For example, in a cluster of four physical TRPs (P_TRPs), if two TRPs are selected for enabling positioning methods at the UE 110, an Associated ID may be assigned to represent the specific physical attributes of these two TRPs. This enables that the network and UE 110 have a consistent understanding of the subset of TRPs used for positioning operations.

Each unique combination of TRPs selected from the cluster requires a distinct Associated ID to accurately reflect their physical properties. For instance, Associated ID_1 may represent P_TRP1 and P_TRP2 in 202, while Associated ID_2 may represent P_TRP1 and P_TRP3 in 210. These TRPs do not necessarily belong to the same gNB but may be managed by different gNBs within the same Mobile Network Operator (MNO). This flexibility allows the network to dynamically adjust TRP selections across its infrastructure while maintaining consistency for the UE through the Associated IDs.

When changes occur in the selection of TRPs over time, the network may either reuse 217 an earlier assigned Associated ID or assign a new unique Associated ID. The reuse or reassignment of IDs depends on the specific configuration needs and is typically scoped within a defined area, such as one represented by an AreaID-CellList.

### Signaling Between LMF 122 and gNBs

The communication between the LMF 122 and gNBs plays an important role in managing and distributing Associated IDs. 203 and 204 describe how the LMF 120 communicates with an NG-RAN node 121, such as a gNB, over NRPPa to obtain information about an Associated ID and its corresponding TRPs. This signaling enables that the Associated ID effectively conveys the physical properties of the TRPs, enabling the LMF 122 to configure the UE 110 with accurate and consistent information.

As network conditions evolve, any changes to the Associated ID or the TRP configuration may be communicated to the LMF 122. 211 and 218 outline the process for updating the LMF 122 with new Associated ID information and TRP configurations. These updates enable that the LMF 122 can provide the UE 110 with the latest configuration data during both the data collection and inference phases. In some scenarios, the LMF 122 may receive multiple Associated IDs from different NG-RAN nodes 121, as shown in 218. These IDs may then be used for AI/ML model training and inference, enabling consistency across various stages of positioning operations.

Alternatively, in scenarios where Associated IDs are directly communicated to the UE 110 by an NG-RAN node 121 over RRC, a similar exchange of information may occur between the gNB and the UE 110. This approach offers flexibility in managing and distributing Associated IDs while maintaining alignment between the network and UE configurations.

### Receiving Associated IDs at the UE 110

The UE 110 may receive at least one Associated ID, along with TRP information, from the LMF 122 (via LPP) or the gNB 121 (via RRC). 205 and 212 describe how this information is delivered to the UE 110, including configuration details for data collection. During inference, additional configurations are provided to the UE 110 as described in 219. The Associated ID allows the UE 110 to maintain consistency in its understanding of the TRPs used for positioning operations.

When the UE 110 receives an Associated ID representing a specific group of TRPs, it assumes consistent physical characteristics for that group, even if the Associated ID is reused within a cell area (e.g., AreaID-CellList). This assumption holds during Positioning Reference Signal (PRS) transmissions, as described in 208, 215, and 223. The Associated ID is directly tied to PRS transmissions, enabling that the UE 110 can associate measurements with the correct TRPs. For example, PRS transmissions in 206 and 207 are associated with Associated ID_1, linking the signals to P_TRP1 and P_TRP2.

For measurements related to a specific Associated ID, the UE 110 may interpret and assume the following consistent properties:
1. Number of TRPs: The number of TRPs represented by an Associated ID remains consistent. If Associated ID_1 is initially configured for three TRPs (e.g., TRP1, TRP2, TRP3), it should always represent three TRPs in future configurations.
2. Ordering of Physical TRPs: The logical ordering of TRP IDs may change dynamically, but the underlying physical TRP arrangement remains stable. For example, if Associated ID_1 maps TRP1, TRP2, and TRP3 to physical TRPs P_TRP2, P_TRP5, and P_TRP7, this mapping should remain consistent over time.
3. Geographical Location Consistency: The geographical locations of TRPs represented by an Associated ID remain similar. For example, if Associated ID_1 maps TRPs to locations G1, G2, and G3, the network enables that future TRPs mapped to Associated ID_1 are in similar locations, allowing for some margin of variation.
4. Reference TRP Consistency: If a reference TRP is included in the group represented by an Associated ID, its geographical location should remain the same. For instance, if TRP1 is the reference TRP for Associated ID_1, the corresponding physical TRP (e.g., P_TRP1) should consistently serve as the reference TRP.

The UE 110 may use these assumptions to categorize data into datasets for model training 216 and to select the appropriate model during inference 220. This enables alignment between training and inference phases, enabling accurate and reliable positioning in dynamic network environments. The mechanism balances network flexibility and UE consistency while safeguarding positioning accuracy across varying configurations.

Now a detailed introduction of the signaling process is described.

The network may select 201 active P_TRPs from a cluster of available TRPs for positioning tasks. For instance, TRP1 may be mapped to P_TRP1, and TRP2 to P_TRP2. These selected TRPs will serve as the sources of Positioning Reference Signals (PRS) for UE positioning.

An Associated ID may be defined to represent the selected P_TRP combination. For example, the combination of P_TRP1 and P_TRP2 is associated with Associated ID_1. This ID uniquely identifies the physical properties of the selected TRPs and enables consistency in their use for data collection and inference.

The LMF 122 may transmit 203 a TRP information request to the NG-RAN node (e.g., gNB) 121 over NRPPa. This request may include details related to data collection for AI/ML Positioning Case 1. The purpose of this communication is to retrieve information about the active P_TRPs and their Associated IDs to enable proper configuration of the UE.

The NG-RAN node 121 may respond 204 to the LMF 122 with a TRP information response. This response may include an indication of Associated ID_1 and the active P_TRPs it represents (e.g., P_TRP1 and P_TRP2). The LMF 122 may use this information to configure the UE 110 for data collection in subsequent steps.

The LMF 122 may communicate 205 the data collection configuration to the UE 110, explicitly indicating the inclusion of Associated ID_1. This allows the UE 110 to align its positioning measurements with the specific TRPs associated with the ID.

PRS transmissions may be transmitted from the active P_TRPs to the UE 110. Specifically, P_TRP1 and P_TRP2, represented by Associated ID_1, may transmit PRS 206, 207 to the UE 110.

The UE may assume 208 that data samples collected under the same Associated ID (in this case, Associated ID_1) correspond to TRPs with similar physical properties. This assumption simplifies the management of collected data and enables consistency during model training and inference.

After some time, new active P_TRPs may be selected 209 by the network. For instance, TRP1 remains mapped to P_TRP1, but TRP2 is now mapped to P_TRP3.

A new Associated ID may be defined 210 to represent the updated P_TRP combination. For example, P_TRP1 and P_TRP3 are now associated with Associated ID_2, enabling that the UE 110 can differentiate this configuration from the previous one.

The TRP information may be updated/exchanged 211 between the LMF 122 and NG-RAN node 121 and an updated data collection configuration may be subsequently communicated 212 to the UE 110. The LMF 122 may inform the UE 110 of the inclusion of Associated ID_2, enabling the UE 110 to align its data collection process with the new configuration.

PRS transmissions may be transmitted from the new active P_TRPs to the UE 110. Specifically, P_TRP1 and P_TRP3, represented by Associated ID_2, may transmit PRS 213, 214 to the UE 110. These signals allow the UE to continue collecting positioning data under the updated configuration.

The UE 110 may assume 215 that data samples collected under Associated ID_2 correspond to TRPs with similar physical properties, just as it did with Associated ID_1. This consistency enables seamless data management across different configurations.

The UE 110 may perform model training 216 using the data collected under each Associated ID. Models are linked to their respective IDs, such as Associated ID_1 and Associated ID_2, enabling that the training process reflects the physical properties of the TRPs used during data collection.

After some time, the network may select 217 again active P_TRPs. For instance, TRP1 is mapped back to P_TRP1, and TRP2 is mapped back to P_TRP2. The network reuses the earlier-defined Associated ID_1 to represent this configuration.

The TRP information may be updated/exchanged 218 between the LMF 122 and NG-RAN node 121 and the inference configuration may be communicated 219 to the UE 110. The LMF 122 may inform the UE 110 of the inclusion of Associated ID_1 for inference purposes, enabling alignment with the earlier data collection phase.

The UE may select 220 the appropriate model based on Associated ID_1 and processes PRS transmissions from the active P_TRPs. P_TRP1 and P_TRP2, indicated by Associated ID_1, transmit PRS 211, 212 to the UE 110, supporting the inference operation.

The UE may perform inference 223 by assuming that PRS measurements under the same Associated ID have the same or similar physical properties as during the training phase. This consistency enables that the AI/ML-based positioning system provides accurate and reliable results, even as the network dynamically manages TRPs over time.

FIG. 3 shows a flowchart of an example method 300 implemented at a first apparatus in accordance with some example embodiments of the present disclosure. For the purpose of discussion, the method 300 will be described from the perspective of the first apparatus 110 in FIG. 1.

At block 310, receiving, from a second apparatus, information comprising a first configuration of a plurality of transmission-reception points (TRPs) and a first association identification, the first association identification associated with at least one TRP of the first configuration of the plurality of TRPs.

At block 320, receiving, from the second apparatus, information comprising a second configuration of a plurality of TRPs, the first association identification associated with at least one TRP of the second configuration of the plurality of TRPs.

At block 330, determining, for the first association identification, that the at least one TRP of the first configuration of the plurality of TRPs and the at least one TRP of the second configuration of the plurality of TRPs are with consistent physical properties.

In some example embodiments, the physical properties comprise at least one of: geolocations of the TRPs, a number of the TRPs, an ordering of the physical TRPs, or a reference TRP.

In some example embodiments, the method 300 further comprises: receiving, for the first association identification, positioning signal transmission from the at least one TRP of the first configuration of the plurality of TRPs; and collecting, for the first association identification, measurements based on the received positioning signal transmission.

In some example embodiments, the method 300 further comprises: training a positioning model corresponding to the first association identification based on the received positioning signal transmission.

In some example embodiments, the method 300 further comprises: receiving, for the first association identification, positioning signal transmission from the at least one TRP of the second configuration of the plurality of TRPs; and collecting, for the first association identification, measurements based on the received positioning signal transmission.

In some example embodiments, the method 300 further comprises: selecting a positioning model corresponding to the first association identification for inference.

In some example embodiments, the method 300 further comprises: receiving, from the second apparatus, information comprising a first configuration of a plurality of further TRPs and a second association identification, the second association identification associated with at least one TRP of the first configuration of the plurality of further TRPs, one out of the plurality of further TRPs being different from the plurality of TRPs associated with the first association identification; receiving, from the second apparatus, information comprising a second configuration of a plurality of further TRPs, the second association identification associated with at least one TRP of the second configuration of the plurality of further TRPs; and determining, for the second association identification, that the at least one TRP of the first configuration of the plurality of further TRPs and the at least one TRP of the second configuration of the plurality of further TRPs are with consistent physical properties.

In some example embodiments, the first association identification or the second association identification is associated with a defined cell area.

In some example embodiments, the geolocations of the TRPs remain same or similar over time.

In some example embodiments, the number of the TRPs remains consistent over time.

In some example embodiments, the ordering of physical TRPs remains consistent over time.

In some example embodiments, the reference TRP remains consistent over time.

In some example embodiments, the first association identification is directly associated with the positioning signal transmission.

In some example embodiments, the first association identification or the second association identification is received over Radio Resource Control (RRC).

In some example embodiments, the first association identification or the second association identification is received over LTE Positioning Protocol (LPP).

In some example embodiments, the first apparatus is or is comprised in a terminal device, and wherein the second apparatus is or is comprised in a network device.

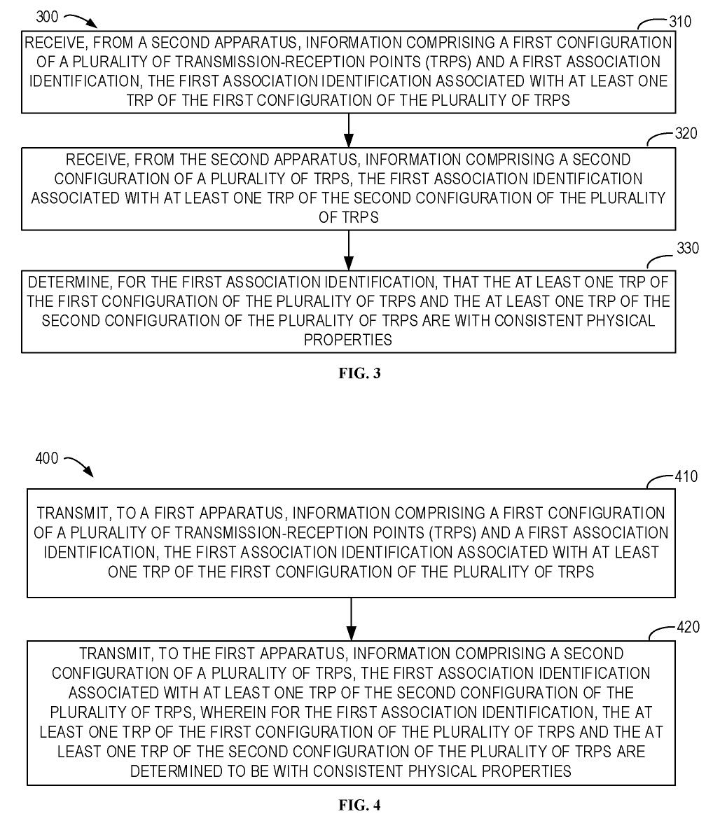

FIG. 4 shows a flowchart of an example method 400 implemented at a second apparatus in accordance with some example embodiments of the present disclosure. For the purpose of discussion, the method 400 will be described from the perspective of the second apparatus 120 in FIG. 1.

At block 410, transmitting, to a first apparatus, information comprising a first configuration of a plurality of transmission-reception points (TRPs) and a first association identification, the first association identification associated with at least one TRP of the first configuration of the plurality of TRPs, and

At block 420, transmitting, to the first apparatus, information comprising a second configuration of a plurality of TRPs, the first association identification associated with at least one TRP of the second configuration of the plurality of TRPs, wherein for the first association identification, the at least one TRP of the first configuration of the plurality of TRPs and the at least one TRP of the second configuration of the plurality of TRPs are determined to be with consistent physical properties.

In some example embodiments, the physical properties comprise at least one of: geolocations of the TRPs, a number of the TRPs, an ordering of the physical TRPs, or a reference TRP.

In some example embodiments, the method 400 further comprises: transmitting, to the first apparatus, information comprising a first configuration of a plurality of further TRPs and a second association identification, the second association identification associated with at least one TRP of the first configuration of the plurality of further TRPs, one out of the plurality of further TRPs being different from the plurality of TRPs associated with the first association identification; and transmitting, to the first apparatus, information comprising a second configuration of a plurality of further TRPs, the second association identification associated with at least one TRP of the second configuration of the plurality of further TRPs, wherein, for the second association identification, the at least one TRP of the first configuration of the plurality of further TRPs and the at least one TRP of the second configuration of the plurality of further TRPs are determined to be with consistent physical properties.

In some example embodiments, the geolocations of TRPs remain same or similar over time.

In some example embodiments, the number of TRPs remains consistent over time.

In some example embodiments, the ordering of physical TRPs remains consistent over time.

In some example embodiments, the reference TRP remains consistent over time.

In some example embodiments, the first apparatus is or is comprised in a terminal device, and wherein the second apparatus is or is comprised in a network device.

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1.

At block 510, receiving, from a second apparatus, information comprising a first configuration of a plurality of transmission-reception points (TRPs) and a first association identification, the first association identification associated with at least one TRP of the first configuration of the plurality of TRPs, and the first configuration of the plurality of TRPs is received for data collection for model training.

At block 520, receiving, from the second apparatus, information comprising a second configuration of a plurality of TRPs, the first association identification associated with at least one TRP of the second configuration of the plurality of TRPs, and the second configuration of the plurality of TRPs is received for inference.

At block 530, receiving, for the first association identification, positioning signal transmission from the at least one TRP of the second configuration of the plurality of TRPs.

At block 540, collecting, for the first association identification, measurements based on the received positioning signal transmission. and

At block 550, selecting a positioning model corresponding to the first association identification for inference, wherein the at least one TRP of the first configuration of the plurality of TRPs and the at least one TRP of the second configuration of the plurality of TRPs are determined to be with consistent physical properties.

In some example embodiments, the physical properties comprise at least one of: geolocations of the TRPs, a number of the TRPs, an ordering of the physical TRPs, or a reference TRP.

In some example embodiments, the first association identification is associated with a defined cell area.

In some example embodiments, the geolocations of the TRPs remain same or similar over time.

In some example embodiments, the number of TRPs remains consistent over time.

In some example embodiments, the ordering of physical TRPs remains consistent over time.

In some example embodiments, the reference TRP remains consistent over time.

In some example embodiments, the method 500 further comprises: receiving, for the first association identification, positioning signal transmission from the at least one TRP of the first configuration of the plurality of TRPs; and collecting, for the first association identification, measurements based on the received positioning signal transmission.

In some example embodiments, the method 500 further comprises: training a positioning model corresponding to the first association identification based on the received positioning signal transmission.

In some example embodiments, the first association identification is directly associated with the positioning signal transmission.

In some example embodiments, the first association identification is received over Radio Resource Control (RRC).

In some example embodiments, the first association identification is received over LTE Positioning Protocol (LPP).

In some example embodiments, a first apparatus capable of performing any of the method 300 (for example, the first apparatus 110 in FIG. 1) may comprise means for performing the respective operations of the method 300. The means may be implemented in any suitable form. For example, the means may be implemented in a circuitry or software module. The first apparatus may be implemented as or included in the first apparatus 110 in FIG. 1 or the UE 110 in FIG. 2.

In some example embodiments, the first apparatus comprises means for receiving, from a second apparatus, information comprising a first configuration of a plurality of transmission-reception points (TRPs) and a first association identification, the first association identification associated with at least one TRP of the first configuration of the plurality of TRPs; means for receiving, from the second apparatus, information comprising a second configuration of a plurality of TRPs, the first association identification associated with at least one TRP of the second configuration of the plurality of TRPs; and means for determining, for the first association identification, that the at least one TRP of the first configuration of the plurality of TRPs and the at least one TRP of the second configuration of the plurality of TRPs are with consistent physical properties.

In some example embodiments, the physical properties comprise at least one of: geolocations of the TRPs, a number of the TRPs, an ordering of the physical TRPs, or a reference TRP.

In some example embodiments, the first apparatus further comprises: means for receiving, for the first association identification, positioning signal transmission from the at least one TRP of the first configuration of the plurality of TRPs; and means for collecting, for the first association identification, measurements based on the received positioning signal transmission.

In some example embodiments, the first apparatus further comprises: means for training a positioning model corresponding to the first association identification based on the received positioning signal transmission.

In some example embodiments, the first apparatus further comprises: means for receiving, for the first association identification, positioning signal transmission from the at least one TRP of the second configuration of the plurality of TRPs; and means for collecting, for the first association identification, measurements based on the received positioning signal transmission.

In some example embodiments, the first apparatus further comprises: means for selecting a positioning model corresponding to the first association identification for inference.

In some example embodiments, the first apparatus further comprises: means for receiving, from the second apparatus, information comprising a first configuration of a plurality of further TRPs and a second association identification, the second association identification associated with at least one TRP of the first configuration of the plurality of further TRPs, one out of the plurality of further TRPs being different from the plurality of TRPs associated with the first association identification; means for receiving, from the second apparatus, information comprising a second configuration of a plurality of further TRPs, the second association identification associated with at least one TRP of the second configuration of the plurality of further TRPs; and means for determining, for the second association identification, that the at least one TRP of the first configuration of the plurality of further TRPs and the at least one TRP of the second configuration of the plurality of further TRPs are with consistent physical properties.

In some example embodiments, the first association identification or the second association identification is associated with a defined cell area.

In some example embodiments, the geolocations of the TRPs remain same or similar over time.

In some example embodiments, the number of the TRPs remains consistent over time.

In some example embodiments, the ordering of physical TRPs remains consistent over time.

In some example embodiments, the reference TRP remains consistent over time.

In some example embodiments, the first association identification is directly associated with the positioning signal transmission.

In some example embodiments, the first association identification or the second association identification is received over Radio Resource Control (RRC).

In some example embodiments, the first association identification or the second association identification is received over LTE Positioning Protocol (LPP).

In some example embodiments, the first apparatus is or is comprised in a terminal device, and wherein the second apparatus is or is comprised in a network device.

In some example embodiments, a second apparatus capable of performing any of the method 400 (for example, the second apparatus 120 in FIG. 1) may comprise means for performing the respective operations of the method 400. The means may be implemented in any suitable form. For example, the means may be implemented in a circuitry or software module. The second apparatus may be implemented as or included in the second apparatus 120 in FIG. 1 or the NG-RAN 121 or the LMF 122 in FIG. 2.

In some example embodiments, the second apparatus comprises means for transmitting, to a first apparatus, information comprising a first configuration of a plurality of transmission-reception points (TRPs) and a first association identification, the first association identification associated with at least one TRP of the first configuration of the plurality of TRPs, and means for transmitting, to the first apparatus, information comprising a second configuration of a plurality of TRPs, the first association identification associated with at least one TRP of the second configuration of the plurality of TRPs, wherein for the first association identification, the at least one TRP of the first configuration of the plurality of TRPs and the at least one TRP of the second configuration of the plurality of TRPs are determined to be with consistent physical properties.

In some example embodiments, the physical properties comprise at least one of: geolocations of the TRPs, a number of the TRPs, an ordering of the physical TRPs, or a reference TRP.

In some example embodiments, the second apparatus further comprises: means for transmitting, to the first apparatus, information comprising a first configuration of a plurality of further TRPs and a second association identification, the second association identification associated with at least one TRP of the first configuration of the plurality of further TRPs, one out of the plurality of further TRPs being different from the plurality of TRPs associated with the first association identification; and means for transmitting, to the first apparatus, information comprising a second configuration of a plurality of further TRPs, the second association identification associated with at least one TRP of the second configuration of the plurality of further TRPs, wherein, for the second association identification, the at least one TRP of the first configuration of the plurality of further TRPs and the at least one TRP of the second configuration of the plurality of further TRPs are determined to be with consistent physical properties.

In some example embodiments, the geolocations of TRPs remain same or similar over time.

In some example embodiments, the number of TRPs remains consistent over time.

In some example embodiments, the ordering of physical TRPs remains consistent over time.

In some example embodiments, the reference TRP remains consistent over time.

In some example embodiments, the first apparatus is or is comprised in a terminal device, and wherein the second apparatus is or is comprised in a network device.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1 or the UE 110 in FIG. 2.

In some example embodiments, the first apparatus comprises means for receiving, from a second apparatus, information comprising a first configuration of a plurality of transmission-reception points (TRPs) and a first association identification, the first association identification associated with at least one TRP of the first configuration of the plurality of TRPs, and the first configuration of the plurality of TRPs is received for data collection for model training; means for receiving, from the second apparatus, information comprising a second configuration of a plurality of TRPs, the first association identification associated with at least one TRP of the second configuration of the plurality of TRPs, and the second configuration of the plurality of TRPs is received for inference; means for receiving, for the first association identification, positioning signal transmission from the at least one TRP of the second configuration of the plurality of TRPs; means for collecting, for the first association identification, measurements based on the received positioning signal transmission; and means for selecting a positioning model corresponding to the first association identification for inference, wherein the at least one TRP of the first configuration of the plurality of TRPs and the at least one TRP of the second configuration of the plurality of TRPs are determined to be with consistent physical properties.

In some example embodiments, the physical properties comprise at least one of: geolocations of the TRPs, a number of the TRPs, an ordering of the physical TRPs, or a reference TRP.

In some example embodiments, the first association identification is associated with a defined cell area.

In some example embodiments, the geolocations of the TRPs remain same or similar over time.

In some example embodiments, the number of TRPs remains consistent over time.

In some example embodiments, the ordering of physical TRPs remains consistent over time.

In some example embodiments, the reference TRP remains consistent over time.

In some example embodiments, the first apparatus further comprises: means for receiving, for the first association identification, positioning signal transmission from the at least one TRP of the first configuration of the plurality of TRPs; and means for collecting, for the first association identification, measurements based on the received positioning signal transmission.

In some example embodiments, the first apparatus further comprises: means for training a positioning model corresponding to the first association identification based on the received positioning signal transmission.

In some example embodiments, the first association identification is directly associated with the positioning signal transmission.

In some example embodiments, the first association identification is received over Radio Resource Control (RRC).

In some example embodiments, the first association identification is received over LTE Positioning Protocol (LPP).

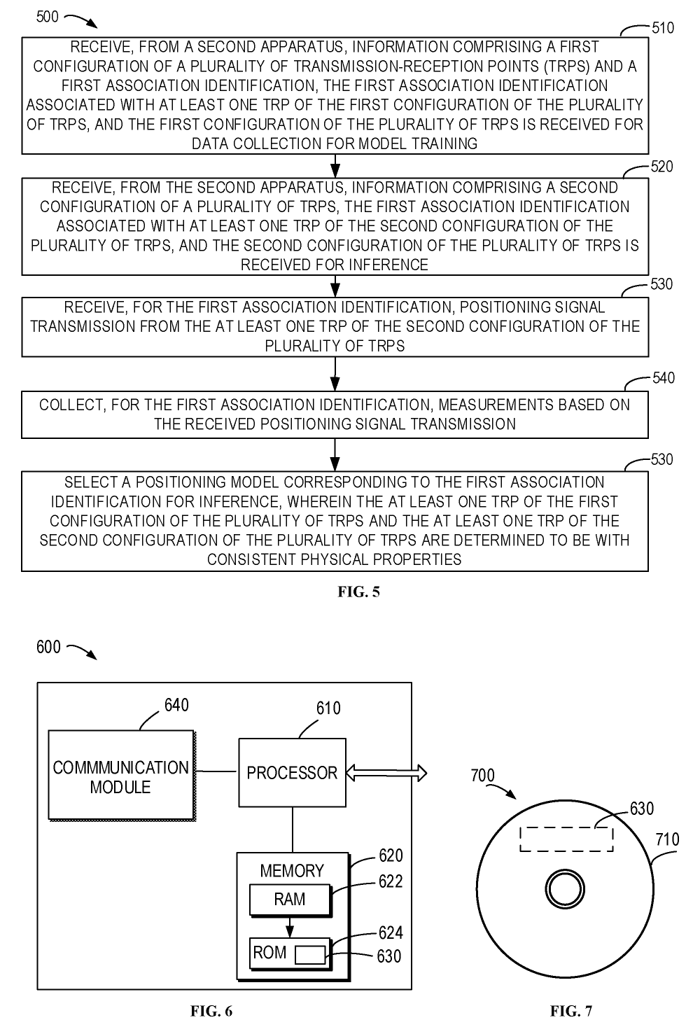

FIG. 6 is a simplified block diagram of a device 600 that is suitable for implementing example embodiments of the present disclosure. The device 600 may be provided to implement a communication device, for example, the terminal device 110 or the network device 120 as shown in FIG. 1, or the UE 110, the NG-RAN 121 or the LMF 122 in FIG. 2. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, information comprising a first configuration of a plurality of transmission-reception points (TRPs) and a first association identification, the first association identification associated with at least one TRP of the first configuration of the plurality of TRPs, and the first configuration of the plurality of TRPs is received for data collection for model training;
receive, from the second apparatus, information comprising a second configuration of a plurality of TRPs, the first association identification associated with at least one TRP of the second configuration of the plurality of TRPs, and the second configuration of the plurality of TRPs is received for inference;
receive, for the first association identification, positioning signal transmission from the at least one TRP of the second configuration of the plurality of TRPs;
collect, for the first association identification, measurements based on the received positioning signal transmission; and
perform inference using a positioning model corresponding to the first association identification,
wherein the at least one TRP of the first configuration of the plurality of TRPs and the at least one TRP of the second configuration of the plurality of TRPs are determined to be with consistent physical properties.

2. The first apparatus of claim 1, wherein the physical properties comprise at least one of:
geolocations of the TRPs,
a number of the TRPs,
an ordering of the physical TRPs, or
a reference TRP.

3. The first apparatus of claim 1, wherein the first association identification is associated with a defined cell area.

4. The first apparatus of claim 1, wherein the geolocations of the TRPs remain same or similar over time.

5. The first apparatus of claim 1, wherein the number of TRPs remains consistent over time.

6. The first apparatus of claim 1, wherein the ordering of physical TRPs remains consistent over time.

7. The first apparatus of claim 1, wherein the reference TRP remains consistent over time.

8. The first apparatus of claim 1, wherein the first apparatus is caused to:
receive, for the first association identification, positioning signal transmission from the at least one TRP of the first configuration of the plurality of TRPs; and
collect, for the first association identification, measurements based on the received positioning signal transmission.

9. The first apparatus of claim 1, wherein the first apparatus is caused to:
train a positioning model corresponding to the first association identification based on the received positioning signal transmission.

10. The first apparatus of claim 1, wherein the first association identification is directly associated with the positioning signal transmission.

11. The first apparatus of claim 1, wherein the first association identification is received over Radio Resource Control (RRC).

12. The first apparatus of claim 1, wherein the first association identification is received over LTE Positioning Protocol (LPP).

13. The first apparatus of claim 1, wherein the performing inference using a positioning model corresponding to the first association identification comprises selecting the positioning model corresponding to the first association identification.

14. A method comprising:
receiving, by a first apparatus and from a second apparatus, information comprising a first configuration of a plurality of transmission-reception points (TRPs) and a first association identification, the first association identification associated with at least one TRP of the first configuration of the plurality of TRPs, and the first configuration of the plurality of TRPs is received for data collection for model training;
receiving, from the second apparatus, information comprising a second configuration of a plurality of TRPs, the first association identification associated with at least one TRP of the second configuration of the plurality of TRPs, and the second configuration of the plurality of TRPs is received for inference;
receiving, for the first association identification, positioning signal transmission from the at least one TRP of the second configuration of the plurality of TRPs;
collecting, for the first association identification, measurements based on the received positioning signal transmission; and
performing inference using a positioning model corresponding to the first association identification,
wherein the at least one TRP of the first configuration of the plurality of TRPs and the at least one TRP of the second configuration of the plurality of TRPs are determined to be with consistent physical properties.

15. The method of claim 14, wherein the physical properties comprise at least one of:
geolocations of the TRPs,
a number of the TRPs,
an ordering of the physical TRPs, or
a reference TRP.

16. The method of claim 14, wherein the first association identification is associated with a defined cell area.

17. The method of claim 14, wherein the first apparatus is caused to:
receive, for the first association identification, positioning signal transmission from the at least one TRP of the first configuration of the plurality of TRPs; and
collect, for the first association identification, measurements based on the received positioning signal transmission.

18. The method of claim 14, wherein the first association identification is received over LTE Positioning Protocol (LPP).

19. The method of claim 14, wherein the performing inference using a positioning model corresponding to the first association identification comprises selecting the positioning model corresponding to the first association identification.

20. A non-transitory computer readable medium comprising instructions stored thereon for causing an apparatus at least to perform:
positioning signal transmission from the at least one TRP of the second configuration of the plurality of TRPs;
collecting, for the first association identification, measurements based on the received positioning signal transmission; and
performing inference using a positioning model corresponding to the first association identification,
wherein the at least one TRP of the first configuration of the plurality of TRPs and the at least one TRP of the second configuration of the plurality of TRPs are determined to be with consistent physical properties.
